(19) United States
(12) Patent Application Publication
(10) Pub. No.: US 2026/0175469 A1
(43) Pub. Date: Jun. 25, 2026

(54) ADDITIVE MANUFACTURING SYSTEMS AND METHODS FOR CERAMIC PARTS AND STRUCTURES

(71) Applicant: Purdue Research Foundation, West Lafayette, IN (US)

(72) Inventors: Benxin Wu, West Lafayette, IN (US); Mengchen Wu, Santa Clara, CA (US)

(73) Assignee: Purdue Research Foundation, West Lafayette, IN (US)

(21) Appl. No.: 19/421,033

(22) Filed: Dec. 16, 2025

Related U.S. Application Data
(60) Provisional application No. 63/738,468, filed on Dec. 23, 2024.

(51) Int. Cl. B28B 1/00; B33Y 10/00; B33Y 30/00

(52) U.S. Cl. CPC B28B 1/001; B33Y 10/00; B33Y 30/00

(57) ABSTRACT

An additive manufacturing process for producing an object from a powder includes directing a pulsed-mode laser beam onto the surface of a powder material layer, and simultaneously directing a continuous-wave laser beam onto the surface of the powder material layer to form the object. The powder material layer includes a ceramic powder.

### CROSS-REFERENCE TO RELATED APPLICATIONS

The present application claims priority to U.S. Provisional Application No. 63/738,468 filed Dec. 23, 2024, titled “ADDITIVE MANUFACTURING SYSTEMS AND METHODS FOR CERAMIC PARTS AND STRUCTURES,” which is hereby incorporated by reference in its entirety.

### TECHNICAL FIELD

The present application relates to additive manufacturing, and more particularly to producing ceramic, or largely ceramic parts, components, structures, features or coatings using pulsed and continuous dual-beam selective laser melting.

### BACKGROUND

This section introduces aspects that may help facilitate a better understanding of the disclosure. Accordingly, these statements are to be read in this light and are not to be understood as admissions about what is or is not prior art.

In many industrial fields, the rapid and flexible production of high-quality ceramic parts with complex and/or customized geometries is highly desirable. Such capabilities are highly desirable for applications in sectors such as aerospace, cutting tools, medical and dental, energy, and other fields. However, achieving these objectives remains a significant challenge due to limitations in existing manufacturing methods. Traditional ceramic manufacturing techniques typically rely on molds, which are often time-intensive and costly to produce, and/or on ceramic machining, which is technically demanding because ceramics are often both brittle and hard. These techniques often have a long lead time in manufacturing and are difficult to produce many complicated geometries. These constraints hinder the feasibility of creating complex-shaped or highly tailored ceramic components in a timely manner.

Additive manufacturing (AM) has emerged as a potential solution to these challenges, offering the promise of greater design freedom and reduced lead times. Despite these advantages, most AM technologies for ceramics do not enable the direct production of parts in a single step. Instead, they often depend on the use of binders to shape the ceramic material, which introduces additional processing requirements. The subsequent debinding step(s) necessary to remove these binders are often time-consuming and can lead to complications such as part distortion, the formation of defects, and environmental pollution, and are particularly problematic for components with significant variations in thickness.

Notable AM processes that can produce ceramic parts largely in a single step include selective laser melting (SLM), direct selective laser sintering (SLS) and directed energy deposition (DED). Using a traditional SLS technique, typically most of the laser-irradiated particles only partially melt, at best. On the other hand, during a typical SLM process, at least some of laser-irradiated particles fully melt. Further, compared with SLM, typically the geometric complexity and accuracy achievable by DED is much lower, and the relative part density achievable by SLS is much smaller than SLM unless additional steps are utilized such as pressing and/or infiltration. Thus, SLM is a preferred AM method for rapidly and flexibly producing—largely in a single step—ceramic parts with complex and/or customized geometries and having a relative density that can theoretically approach 100%. These manufacturing capabilities for ceramics are highly desirable in many industrial fields.

However, in many instances, ceramic parts produced by SLM may suffer from quality problems, such as cracks, balling, high roughness and/or poor densification. As a result, there exists a pressing need for advancements in ceramic part manufacturing methods that can address these quality problems in SLM. The inventors of the present disclosure have endeavored to meet this need.

### SUMMARY

The present disclosure describes methods and systems for producing ceramic, or largely ceramic, parts, components, structures, features or coatings using pulsed and continuous dual-beam selective laser melting. An additive manufacturing process for producing an object from a powder can include directing a pulsed-mode laser beam onto the surface of a powder material layer, and simultaneously directing a continuous-wave laser beam onto the surface of the powder material layer to form the ceramic object. The powder material layer includes a ceramic powder. In some embodiments, the powder material layer can be disposed over a solid surface.

It should be noted that a laser beam in “continuous-wave” (CW) mode may also be turned on and off during laser processing. It can be turned off through the laser source and/or external device(s) outside the laser source. When a CW laser beam is turned on, it delivers laser power continuously with time. On the other hand, a pulsed laser beam, even when it is turned on, does not deliver laser power continuously with time. Instead, it delivers laser power in the form of one or multiple pulses, wherein the laser power is larger than zero within each pulse and the laser power is zero or close to zero between adjacent laser pulses.

In this disclosure, “melting” of ceramics includes both the traditionally defined melting and the situation where a ceramic first decomposes into multiple components and then one or multiple of the components melt. The “heat-affected region” induced by a laser beam is defined as the region, wherein the material temperature is changed due to the laser beam irradiation, typically by more than ˜10 degrees.

In one aspect, variations of the disclosed additive manufacturing method may include a dual-beam laser process comprising a pulsed melting laser beam and a continuous wave heating laser beam for ceramic powder processing. The method comprises directing a first laser beam operating in pulsed mode onto ceramic powder to create transient high-intensity for ceramic melting while limiting melt pool size, directing a second laser beam operating in continuous wave mode to reduce temperature gradients caused by the first laser beam, and moving both laser beams relative to the powder layer to form densified ceramic material. The approach of using a pulsed melting beam can potentially provide sufficient laser intensity for complete powder melting while preventing the overlarge melt pools and excessive melt flow that may happen continuous wave dual-beam systems are used, while the continuous wave heating beam can potentially: (1) reduce the temperature gradients and excessive Marangoni flow in the melt pool that may often cause material irregularity in single-beam systems, and/or (2) the temperature gradients in the sold region that may often cause cracks, thereby enabling production of ceramic parts with improved continuity, densification, reduced cracking and/or lower surface roughness compared to other laser powder bed fusion approaches.

In one aspect, variations of the disclosed additive manufacturing system may include a dual-laser configuration for ceramic part fabrication. The system comprises a first laser source configured to generate a pulsed melting beam for ceramic powder melting, a second laser source configured to generate a continuous wave heating beam, and a motion mechanism configured to move both laser beams relative to ceramic powder layers while ensuring the heat-affected region induced by the heating beam at least partially overlaps the heat-affected region induced by the melting beam. The integrated design can potentially eliminate or reduce the material irregularity and/or cracking challenges often associated with single-beam ceramic processing while avoiding the melt overflow, material balling and/or high surface roughness that often occur with dual continuous wave beam systems, providing controlled ceramic additive manufacturing with multi-layer build capabilities.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1A depicts a schematic of one exemplary pulsed-continuous dual-beam selective laser melting (SLM) process for forming ceramic (or largely ceramic) objects;

FIG. 1B depicts a top view of a first example of relative locations of the first laser beam (i.e., melting) spot and second laser beam (i.e., heating) spot on the powder layer surface;

FIG. 1C depicts a top view of a second example of relative locations of the first laser beam (i.e., melting) spot and second laser beam (i.e., heating) spot on the powder layer surface; and

FIG. 1D depicts a top view of a third example of relative locations of the first laser beam (i.e., melting) spot and second laser beam (i.e., heating) spot on the powder layer surface.

FIG. 2A illustrates a flowchart showing the expected quality-problem generating mechanisms of dual-beam laser powder bed fusion using two continuous wave laser beams, according to some embodiments;

FIG. 2B illustrates a flowchart showing the expected quality-problem generating mechanisms of single-beam laser powder bed fusion, according to some embodiments;

FIG. 2C illustrates a flowchart showing the expected process sequence and successful operation of pulsed-continuous dual-beam laser powder bed fusion, according to some embodiments; and

FIG. 3 illustrates a flowchart showing the method of ceramic additive manufacturing using the pulsed-continuous dual-beam laser powder bed fusion process, according to some embodiments.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown, or the precise experimental arrangements used to arrive at the various graphical results shown in the drawings.

### DETAILED DESCRIPTION OF THE ILLUSTRATED EMBODIMENTS

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

For clarity and consistency, the same reference numerals will be used throughout the detailed description to refer to the same or corresponding components across the various figures. When a particular component is discussed while referring to a figure different from the one in which the component first appears, the reference numeral and original figure will be cited for clarity.

Terms such as “first,” “second,” “pulsed,” “continuous,” “melting,” and “heating” may be used in the following description for clarity with respect to the function and operation of laser beams as shown in the figures. These terms are not intended to be limiting and may be interpreted relative to the configuration or operation of the additive manufacturing system in actual use, which may vary.

Unless otherwise specified, the singular forms “a,” “an,” and “the” include plural referents. Components may be described functionally rather than structurally where appropriate for clarity. Any features or configurations disclosed as being optional or alternative may be implemented individually or in any suitable combination, as would be understood by one of ordinary skill in the art.

The disclosed dual-beam laser powder bed fusion system may include ceramic powder materials formed from carbides, oxides, nitrides, other types of ceramics, or composite ceramic materials. The systems may be configured to potentially address the challenges of overlarge melt pools and excessive temperature gradients through coordinated pulsed melting and continuous wave heating laser operation. In some embodiments, ceramic material formulations such as chromium carbide, aluminum oxide, zirconium oxide, or other ceramics may be used.

The dual-beam laser powder bed fusion system may comprise a pulsed melting laser beam and a continuous wave heating laser beam that can potentially enable controlled ceramic part fabrication. The pulsed melting beam may be configured to provide high transient power density for complete melting of some powder particles while limiting energy-affected zone size and material molten-state duration, potentially avoiding the overlarge melt pools and excessive melt flow often associated with continuous wave dual-beam systems. The heating laser beam may be positioned to irradiate the same region as the melting beam with a larger spot size and may feature continuous wave operation to reduce temperature gradients during melting cycles. The heating beam may be configured to reduce surface tension gradients in the melt pool, potentially decreasing driving forces for problematic melt flow that causes material irregularity, fragmentation and/or poor densification upon solidification.

The dual-beam laser powder bed fusion system may also include motion control mechanisms positioned to move both laser beams relative to the powder layer surface, which may be configured to provide coordinated beam movement and synchronized scanning capabilities for controlled ceramic track formation and layer-by-layer part building.

The dual-beam laser powder bed fusion system may be configured to operate with heating beam spot sizes larger than melting beam spot sizes to reduce temperature gradients in and/or around the melting zone.

The dual-beam laser powder bed fusion system may include multiple operational configurations designed for different ceramic types, including carbide and oxide materials. Each system configuration may incorporate the same dual-beam principles while providing specialized processing parameters to address specific ceramic material requirements.

In use, users may position ceramic powder layers according to part geometry requirements and engage the dual-beam mechanisms to create controlled ceramic additive manufacturing functionality. The systems may be operated by depositing powder layers according to part geometry requirements and activating both laser beams to scan the powder surface. The pulsed melting beam melts ceramic powder through high transient intensity while the heating beam reduces temperature gradients, potentially creating densified ceramic material upon solidification that maintains proper material quality. The dual-beam mechanism can operate through coordinated scanning of laser spots on the powder layer surface.

The pulsed-continuous dual-beam selective laser melting process or system can be potentially utilized in many applications that desire rapid, flexible manufacturing of high-quality ceramic parts, components or structures, in customized and/or complex shapes, with a short lead time. Some examples may include: (1) manufacturing customer-specific ceramic devices such as ceramic medical implants, (2) manufacturing ceramic parts or components with complex geometries that are desired for superior performance, but difficult to make conventionally, (3) manufacturing critical ceramic parts, of which only small quantities are needed, and (4) manufacturing ceramic parts under design and development to achieve rapid part testing and accelerated development of new products

In many instances, ceramic parts produced by SLM may suffer from cracks, balling, high roughness and/or poor densification, often due to at least one of the following three challenges faced by SLM: high temperature gradients, insufficient melting, or an overlarge melt pool. Each challenge is discussed separately below.

High temperature gradients. Ceramics typically have a high melting temperature and low thermal conductivity. Thus, high temperature gradients are often generated in SLM of ceramics. A high temperature gradient in the solid region can generate large thermal stresses and cracks. A high temperature gradient in the melt pool can lead to a high gradient of surface tension, causing significant Marangoni flow. As molten material flows, some portions of the melt pool may have a net gain of material while some portions may have a net loss. This may change the melt pool into an irregular or even fragmented shape. The re-solidification of such a melt pool may lead to irregular or fragmented solid material, and thus a part with high surface roughness, poor dimensional accuracy and/or low density.

Insufficient melting. Due to the high melting points of ceramic powders, a very high laser power density is required to fully melt at least some of laser-irradiated ceramic particles. If the laser power density is not high enough, insufficient melting of ceramic particles may occur, causing a low density of the part produced.

Overlarge melt pool. If laser induces an overlarge melt pool, the molten material may overflow beyond the intended boundary of the part, causing high surface roughness of the part. A melt pool with an overlarge size in the length direction can also be prone to Rayleigh instability, wherein surface tension may drive the flowing of the melt into balls, leading to the harmful “balling” phenomenon upon solidification.

If a unique pre-determined set of parameter values is utilized for an SLM process that is based upon the particular ceramic and desired shape, the challenges described above do not necessarily occur simultaneously; however, preventing all three challenges in each application may be difficult. Preventing insufficient melting requires that the laser power density that is absorbed by the powder is large enough. Meanwhile, preventing high temperature gradients requires a temperature gradient small enough, and preventing an overlarge melt pool requires the laser energy density absorbed and/or the energy-affected region to be small enough to produce a sufficiently small melt pool. These requirements may contradict each other to a certain extent and thus can be challenging to satisfy simultaneously with single-beam SLM or dual-beam SLM using two continuous-wave (CW) lasers. Some existing methods include using two CW lasers; however, using two CW lasers in dual-beam SLM of ceramics often generates serious side effects, such as the overflow of molten material across the intended boundary of the part being built, leading to high surface roughness and low dimensional accuracy of the ceramic part. The overflow of the molten material likely stems from the overlarge size of the melt pool formed under the irradiation of the two laser beams that are both in the CW mode. Thus, improvements are needed in the methods used to produce high-quality ceramic parts using SLM which will be discussed.

It should be noted that the use cases described above are merely illustrative examples of how the dual-beam laser powder bed fusion system may be utilized, and the practical applications are not limited to these specific scenarios. The pulsed-continuous dual-beam design and coordinated scanning features make the system potentially suitable for a wide variety of ceramic additive manufacturing applications where the produced part quality can be potentially much better than those by conventional single-beam or dual continuous wave laser powder bed fusion systems.

The disclosed dual-beam laser powder bed fusion process offers an advanced alternative to conventional single-beam or dual continuous-wave laser beam approaches and it is configured to address the material quality challenges of ceramic additive manufacturing applications. By incorporating pulsed melting laser technology, continuous wave heating beam operation, and coordinated dual-beam scanning, the system can potentially enable controlled ceramic part fabrication without an overlarge melt pool while greatly alleviating the temperature gradient issues associated with single-beam techniques.

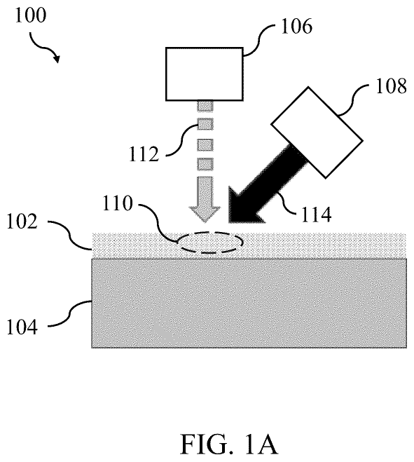

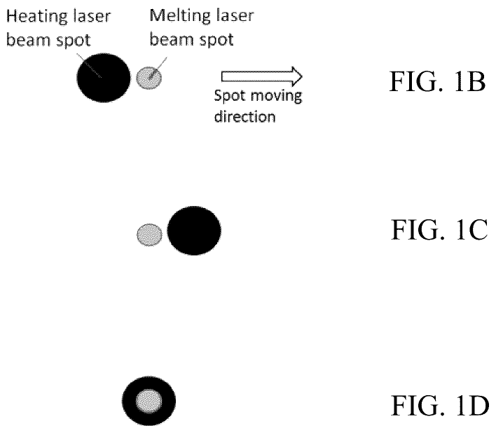

FIG. 1A illustrates a schematic view of a pulsed-continuous dual-beam selective laser melting system 100 according to one embodiment of the disclosed invention. The pulsed-continuous dual-beam selective laser melting (PC-DB-SLM) system 100 represents a configuration for additive manufacturing of ceramic parts through laser processing of powder materials. The selective laser melting (SLM) process involves laser scanning of selective region(s) of a powder layer in a layer-by-layer manner to manufacture parts with complex geometries. During SLM, at least some particles in the laser-scanned region(s) of each layer undergo full melting, coalescence with adjacent melted particles, and resolidification into a continuous or substantially continuous medium. The PC-DB-SLM system 100 can produce ceramic parts with complicated geometries that are difficult to manufacture using traditional ceramic part manufacturing methods.

The PC-DB-SLM system 100 comprises a solid surface 104 that provides a base for supporting powder material during processing. The solid surface 104 may comprise a bulk solid substrate, a powder bed that has been previously processed and solidified, or a solid surface fabricated in other forms. The solid surface 104 positions to receive one or multiple powder layers and maintain stability during laser irradiation operations.

The PC-DB-SLM system 100 further comprises a powder layer 102 positioned on the solid surface 104. The powder layer 102 comprises ceramic powder spread onto the surface of the solid surface 104. The powder layer 102 may consist fully of ceramic powder or may comprise mostly ceramic powder with small amounts of other materials. The powder layer 102 comprises particles with spaces between particles, creating a porous structure prior to laser processing. The ceramic powder in the powder layer 102 comprises particles that melt, coalesce, and resolidify during the PC-DB-SLM process to form densified ceramic material.

The PC-DB-SLM system 100 comprises a first laser 106 configured to generate and deliver a first laser beam 112. The first laser 106 positions to direct the first laser beam 112 onto a selected region 110 of the powder layer 102. The selected region 110 represents the area of the powder layer 102 where laser processing occurs during a given scanning operation. The first laser beam 112 is referred to as the melting laser beam or melting beam because its primary intended function involves melting of at least some ceramic particles in the powder layer 102 to form a melt pool. The first laser 106 operates in a pulsed beam mode, wherein the first laser beam 112 delivers laser power not continuously with time, but in the form of one or multiple pulses. The pulsed operation of the first laser beam 112 creates discrete bursts of laser energy delivered to the powder layer 102 rather than continuous energy delivery.

The pulsed mode of the first laser beam 112 enables the system 100 to potentially achieve multiple objectives simultaneously. The first laser beam 112 generates a transient peak power density during each pulse that is large enough to fully melt at least some of the ceramic particles irradiated by the first laser beam 112. This high transient power density can potentially address the challenge of insufficient melting that occurs when laser intensity is inadequate for complete particle melting. The first laser beam 112 can also potentially generate a density of laser energy absorbed by the powder layer 102, and/or a laser energy-affected region in the powder layer 102, that are sufficiently small to avoid formation of an overlarge melt pool. The energy density and/or energy-affected region can remain limited because the pulsed operation provides energy only during each pulse duration rather than continuously. This limited energy density and/or energy-affected region can potentially address the challenge of overlarge melt pools that may lead to material overflow, balling, and/or high surface roughness. The pulsed melting beam 112 has adjustable parameters including transient power density within each pulse, pulse duration, pulse-to-pulse time interval, and duty cycle, wherein the duty cycle represents the percentage of time during which the first laser beam 112 power is on (obviously higher than zero). These adjustable parameters enable the first laser beam 112 to potentially achieve both adequate extent of melting and limited melt pool size, objectives that are difficult to achieve simultaneously using a continuous-wave melting beam.

The PC-DB-SLM system 100 further comprises a second laser 108 configured to generate and deliver a second laser beam 114. The second laser 108 positions to direct the second laser beam 114 onto the selected region 110 of the powder layer 102. The second laser beam 114 is referred to as the heating laser beam or heating beam because its primary intended function involves heating ceramic material. The second laser 108 operates in a continuous wave (CW) mode, wherein the second laser beam 114 delivers laser power continuously with time when it is not turned off. The second laser beam 114 can potentially reduce temperature gradients in at least a portion of material in the laser-induced melt pool created by the first laser beam 112 and/or in at least a portion of solid material thermally affected by the first laser beam 112. The second laser beam 114 thermally affects a region that overlaps with or partially overlaps with the region thermally affected by the first laser beam 112 such that the second laser beam 114 can potentially reduce temperature gradients in at least a portion of the region thermally affected by the first laser beam 112.

The second laser beam 114 has a power density large enough and a spot size on the powder layer 102 surface large enough to potentially effectively reduce temperature gradients caused by the first laser beam 112. The potentially reduced temperature gradient in the melt pool may decrease the surface tension gradient across the melt pool because surface tension of molten ceramic can vary with temperature. The decreased surface tension gradient can reduce melt flow driven by surface tension gradients. The potentially reduced temperature gradient in the solidified region can decrease thermal stresses in the resolidified material, reducing crack formation caused by thermal stress. The second laser beam 114 can potentially address the challenge of high temperature gradients that may cause excessive melt flow problems and/or thermal cracking in single-beam SLM processes. The power density and spot size of the second laser beam 114 remain small enough to potentially avoid formation of an overlarge melt pool, an overlarge heat-affected zone and/or overlarge grains in the ceramic material.

The transient power density within each pulse of the first laser beam 112 is configured to be large enough to fully melt at least some ceramic particles irradiated by the first laser beam 112. The pulse duration, pulse repetition rate, and duty cycle of the first laser beam 112 are configured to be large enough to produce a sufficiently long molten state duration for ceramic material in the powder layer 102 to enable full coalescence of adjacent melted ceramic particles in at least a portion of the powder layer 102. The pulse duration, pulse repetition rate, and duty cycle are also configured to be small enough to potentially avoid an overlarge melt pool and an overlarge molten state duration that could cause high surface roughness, significant balling, and/or irregularity in the resolidified material after SLM processing.

The scanning of the first laser beam 112 and second laser beam 114 on the powder layer 102 surface is achieved through motion of the spots of the laser beams on the powder layer 102 surface, motion of the solid surface 104, or a combination of both motions. The first laser beam 112 and second laser beam 114 scan across the selected region 110 to process ceramic powder in that region through melting and resolidification. The angle of propagation direction of the first laser beam 112 relative to the surface of the powder layer 102 may range from greater than zero degrees to ninety degrees. The angle of propagation direction of the second laser beam 114 relative to the surface of the powder layer 102 may range from greater than zero degrees to ninety degrees. The angle of the propagation direction of the first laser beam 112 relative to the propagation direction of the second laser beam 114 may range from zero degree to less than 180 degrees. The spots of the first laser beam 112 and second laser beam 114 on the powder layer 102 surface may have various shapes including circular, elliptical, or other geometries.

The first laser beam 112 and second laser beam 114 may have various wavelengths provided that the powder layer 102 absorbs the laser energy sufficiently. The ceramic powder in the powder layer 102 absorbs laser energy at wavelengths where the ceramic material has adequate absorption properties. For wavelengths where the ceramic powder does not absorb laser energy sufficiently, a small amount of laser-absorbing material may be mixed into the ceramic powder to enhance laser absorption and enable effective laser processing.

The PC-DB-SLM process can be performed on a single layer of powder or on multiple layers of powder in a layer-by-layer procedure to build three-dimensional ceramic parts. The PC-DB-SLM system 100 and processes enable production of ceramic coatings on solid substrates or manufacture of ceramic parts, components, structures, or features through sequential processing of powder layers.

In some embodiments, the first laser 106 comprises a fiber laser with a wavelength of approximately 1075 nanometers. In some embodiments, the first laser beam 112 operates with an average power per second between 10 watts and 300 watts. In some embodiments, the first laser beam 112 operates with a pulse duration between 1 microsecond and 100 microseconds. In some embodiments, the first laser beam 112 operates with a pulse repetition rate between 5 kilohertz and 100 kilohertz. In some embodiments, the first laser beam 112 creates a spot on the powder layer 102 surface with a circular shape having a diameter between 50 micrometers and 900 micrometers. In some embodiments, the second laser 108 comprises a diode laser with a wavelength of approximately 976 nanometers. In some embodiments, the second laser beam 114 operates with an average power between 30 watts and 300 watts. In some embodiments, the second laser beam 114 creates a spot on the powder layer 102 surface with an approximately elliptical shape having a major axis diameter between 2 millimeters and 10 millimeters and a minor axis diameter between 1 millimeters and 5 millimeters. In some embodiments, the spot of the second laser beam 114 is at least three times larger than the spot of the first laser beam 112 in lateral size. In some embodiments, the first laser beam 112 and second laser beam 114 scan relative to the powder layer 102 surface at speeds between 10 millimeters per second and 300 millimeters per second.

In some embodiments, the powder layer 102 comprises chromium carbide powder. In some embodiments, the powder layer 102 comprises aluminum oxide powder. In some embodiments, the powder layer 102 comprises zirconium oxide powder. In some embodiments, the powder layer 102 has a thickness between 30 micrometers and 500 micrometers. In some embodiments, the powder layer 102 has an initial porosity between 40 percent and 70 percent prior to laser processing. In some embodiments, the solid surface 104 comprises a metal substrate such as aluminum alloy. In some embodiments, the solid surface 104 comprises a previously processed and solidified powder bed layer.

In some embodiments, the PC-DB-SLM system 100 operates in a vacuum environment to avoid chemical reactions between the powder and ambient gases. In some embodiments, the PC-DB-SLM system 100 operates in an inert gas environment comprising argon to avoid oxidation or other harmful chemical reactions during laser processing. In some embodiments, laser-absorbing material is mixed into the ceramic powder at concentrations between 0.1 percent and 5 percent by weight to enhance laser energy absorption for wavelengths where the ceramic powder has insufficient natural absorption.

In some embodiments, a PC-DB-SLM experiment is performed using chromium carbide powder with a particle size of less than 44 micrometers. In some embodiments, the first laser beam 112 in the experiment has a wavelength of approximately 1075 nanometers, an average power of approximately 30 watts, a pulse duration of approximately 3 microseconds, and a pulse repetition rate of approximately 20 kilohertz. In some embodiments, the spot of the first laser beam 112 on the surface of the powder layer in the experiment has a circular shape with a diameter of approximately 660 micrometers. In some embodiments, the second laser beam 114 in the experiment has a wavelength of approximately 976 nanometers and an average power of approximately 100 watts. In some embodiments, the spot of the second laser beam 114 in the experiment has an elliptical shape with a major axis diameter of approximately 5.8 millimeters and a minor axis diameter of approximately 3.8 millimeters. In some embodiments, the laser beams in the experiment scan at a speed of approximately 30 millimeters per second relative to the surface of the powder layer. In some embodiments, the spot of the first laser beam 112 is spatially contained within the spot of the second laser beam 114 during scanning. In some embodiments, the experiment is conducted in an argon gas environment. In some embodiments, the ceramic track produced by PC-DB-SLM in the experiment appears more continuous, uniform, and densified than tracks produced by dual-beam SLM using two continuous wave beams, single-beam SLM using a continuous wave beam, or single-beam SLM using a pulsed beam without a heating beam.

FIG. 1B illustrates a first scanning configuration showing the heating laser beam spot and melting laser beam spot with their relative sizes and positioning on the powder layer surface according to the same embodiment shown in FIG. 1A. The scanning configuration demonstrates the spatial relationship between the spots created by the first laser beam 112 and second laser beam 114 on the powder layer 102 surface as the spots move together during laser processing operations. The first scanning configuration represents one of multiple possible scanning configurations defined by the spots of the first laser beam 112 and second laser beam 114.

The heating laser beam spot represents the area on the powder layer surface irradiated by the second laser beam 114 of FIG. 1A. The heating laser beam spot appears as a larger circular region that defines the zone where the second laser beam heats ceramic powder. The size of the heating laser beam spot affects the size of the region thermally affected by the heating laser beam during laser processing operations.

The melting laser beam spot represents the area on the powder layer surface irradiated by the first laser beam 112 of FIG. 1A. The melting laser beam spot appears as a smaller circular region positioned adjacent to the heating laser beam spot. The size of the melting laser beam spot is one of the important factors that determine the zone where ceramic powder undergoes melting due to the high transient intensity of the pulsed first laser beam. Typically, the melting laser beam spot has a size smaller than the size of the heating laser beam spot, creating a focused melting zone surrounded by a broader heating zone.

The melting laser beam spot and heating laser beam spot can partially overlap. This positioning enables the second laser beam to directly irradiate a portion of the region directly irradiated by the first laser beam to reduce temperature gradients induced by the first laser beam.

The spot moving direction arrow indicates the direction that both the melting laser beam spot and heating laser beam spot travel on the powder layer surface during processing. Typically, the melting laser beam spot and heating laser beam spot move together in the same direction at the same speed, maintaining their relative positioning throughout the scanning operation. The typical synchronized movement of both spots ensures that the heating effect of the second laser beam can potentially continuously reduce temperature gradients created by the first laser beam for at least a portion of the region thermally affected by the first laser beam as the beams travel on the scan path. However, the invention includes embodiments wherein the melting laser beam spot and heating laser beam spot do not move together or do not move along the same scan path, but the laser processing operation is based on a similar dual-beam concept, wherein the melting laser beam is intended to melt some of irradiated material while the heating laser beam is intended to reduce temperature gradient of at least a portion of material in the heat-affected region induced by the melting laser beam.

The coordinated movement of the melting laser beam spot and heating laser beam spot on the powder layer surface creates a solidified track of ceramic material. As the spots move together, the first laser beam melts some ceramic powder in the melting laser beam spot while the second laser beam heats the region in and around the heating laser beam spot. The melted ceramic solidifies after the laser beams pass, potentially forming a continuous track with improved material quality compared to tracks formed by single-beam or dual continuous-wave (CW) beam approaches. The size relationship between the heating laser beam spot and melting laser beam spot helps the heating beam to potentially reduce the temperature gradient caused by the melting beam.

In some embodiments, the heating laser beam spot has a circular shape with a diameter between 1 millimeters and 10 millimeters. In some embodiments, the melting laser beam spot has a circular shape with a diameter between 100 micrometers and 900 micrometers. In some embodiments, the ratio of the heating laser beam spot diameter to the melting laser beam spot diameter is at least 3 to 1. In some embodiments, the ratio is at least 5 to 1. In some embodiments, the spots move on the powder layer surface at speeds between 10 millimeters per second and 300 millimeters per second. In some embodiments, the scan path follows a linear trajectory to create straight tracks. In some embodiments, the laser scan path follows curved or complex trajectories to create parts with intricate geometries.

FIG. 1C illustrates a second scanning configuration showing the relative positioning of the heating laser beam spot and melting laser beam spot according to the same embodiment shown in FIG. 1A. The second scanning configuration demonstrates a variation in the spatial relationship between the spots created by the first laser beam 112 and second laser beam 114 as the spots move during laser processing operations. The second scanning configuration provides an alternative arrangement compared to the first scanning configuration shown in FIG. 1B.

The melting laser beam spot appears as the smaller circular region positioned adjacent to the heating laser beam spot. The melting laser beam spot represents the area where the first laser beam 112 of FIG. 1A irradiates the powder layer surface to melt ceramic powder through pulsed laser operation. Typically, the melting laser beam spot maintains the same smaller size as shown in FIG. 1B, creating a focused melting zone for ceramic powder processing.

The heating laser beam spot appears as the typically larger circular region positioned adjacent to the melting laser beam spot. The heating laser beam spot represents the area where the second laser beam 114 of FIG. 1A irradiates the powder layer surface to heat ceramic powder through continuous wave operation. Typically, the heating laser beam spot maintains a larger size than the melting laser beam spot, creating a larger heating zone than the melting region.

The melting laser beam spot and heating laser beam spot position with no or partial overlap. The partial overlap configuration enables the second laser beam to heat a region irradiated by the first laser beam while the heating laser beam extends beyond the region irradiated by the melting laser beam. This positioning can potentially reduce temperature gradients induced by the first laser beam while enabling the heating beam to preheat material ahead of the melting beam as the spots move together on the powder layer surface.

The offset positioning of the melting laser beam spot relative to the heating laser beam spot provides flexibility in controlling the thermal profile during ceramic powder processing. The degree of overlap between the spots determines the extent to which the heating beam affects the melting zone versus affecting surrounding regions.

In some embodiments, the melting laser beam spot and heating laser beam spot overlap by 25 percent to 75 percent of the melting laser beam spot diameter. In some embodiments, the spots overlap by 50 percent of the melting laser beam spot diameter. In some embodiments, the offset between spot centers ranges from 1 millimeter to 10 millimeters.

FIG. 1D illustrates a third scanning configuration according to the same embodiment shown in FIG. 1A. The third scanning configuration demonstrates a situation where the melting laser spot (in a circular, elliptical, or other shape) is fully contained within the heating laser beam spot (in a circular, elliptical, or other shape). The third scanning configuration offers another alternative arrangement for coordinating the first laser beam 112 and second laser beam 114 during scanning. In this configuration, all the material irradiated by the melting laser beam spot is also irradiated by the heating laser beam spot. As the laser beam spots move together, material ahead of the melting laser beam spot is preheated by the heating laser beam spot, while material that passes through the melting laser beam spot is reheated by the heating laser beam spot.

In some embodiments, the heating laser beam spot has a diameter between 1 millimeters and 10 millimeters. In some embodiments, the melting laser beam spot has a diameter less than 1 millimeter. In some embodiments, the melting laser beam spot positions concentrically with the heating laser beam spot. In some embodiments, the center of the melting laser beam spot has a certain distance from the center of the heating laser beam spot.

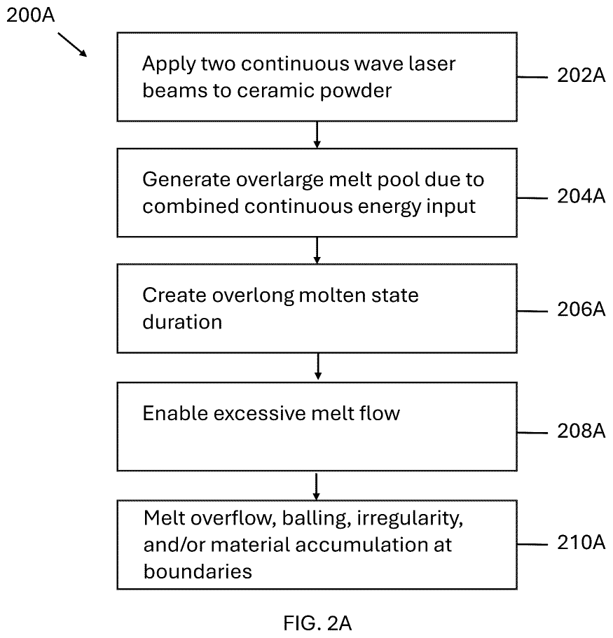

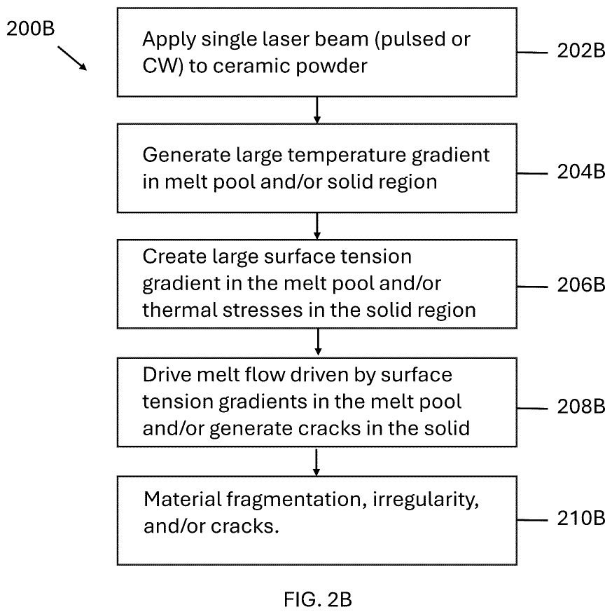

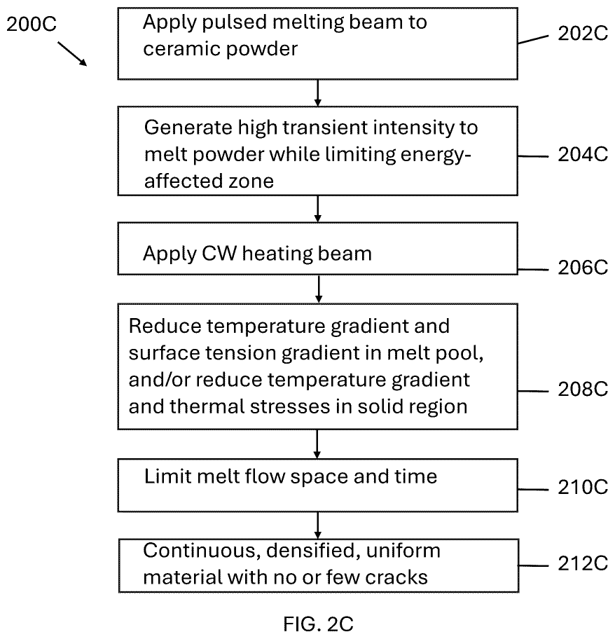

FIG. 2A illustrates a flowchart showing the expected quality-problem generating mechanisms of dual-beam laser powder bed fusion using two continuous wave laser beams according to some embodiments. The flowchart 200A demonstrates the material quality challenges often encountered when both laser beams operate in continuous wave mode rather than the pulsed-continuous combination disclosed in FIGS. 1A through 1D. The process 200A is referred to as continuous wave-continuous wave dual-beam selective laser melting (CC-DB-SLM) to distinguish it from the pulsed-continuous dual-beam selective laser melting (PC-DB-SLM) system 100 shown in FIG. 1A. The flowchart 200A provides context for understanding the technical improvements achieved through the disclosed PC-DB-SLM approach.

The process 200A begins at operation 202A, which involves applying two continuous wave laser beams to ceramic powder. During operation 202A, a first continuous wave laser beam directs onto a powder layer surface to melt ceramic powder while a second continuous wave laser beam simultaneously directs onto the powder layer surface to heat ceramic powder. Both laser beams operate in continuous wave mode, meaning both beams deliver laser power continuously with time when they are not turned off rather than one beam operating in pulsed mode as in the PC-DB-SLM system 100 of FIG. 1A. The two continuous wave laser beams irradiate overlapping, partially overlapping, or adjacent regions of the powder layer, combining their energy inputs into the ceramic powder during processing. The first continuous wave laser beam functions as a melting beam similar to the first laser beam 112 of FIG. 1A but operates in continuous wave mode instead of pulsed mode. The second continuous wave laser beam functions as a heating beam similar to the second laser beam 114 of FIG. 1A and operates in continuous wave mode. Operation 202A establishes the dual continuous wave configuration that leads to the subsequent material quality problems shown in the following operations.

At operation 204A, the process 200A involves generating an overlarge melt pool due to combined continuous energy input. The continuous energy delivery from both laser beams accumulates in the powder layer, creating a melt pool larger than the melt pool that would form from a single continuous wave beam or from a pulsed melting beam combined with a continuous wave heating beam as in the PC-DB-SLM system 100 of FIG. 1A. The combined continuous energy input from both beams increases the total energy density and/or the size of the energy-affected region in the powder layer, expanding the zone where ceramic powder peak temperature exceeds the melting point. The overlarge melt pool can extend beyond the intended track width. The continuous-wave mode of both beams prevents the energy density or energy-affected region limitation that the pulsed melting beam 112 of FIG. 1A can potentially achieve. Operation 204A demonstrates the melt pool size problem that results from using two continuous wave beams.

Operation 206A involves creating an overlong molten state duration. The duration that a given point in the powder layer remains in the molten state depends on the size of the melt pool in the scanning direction and the scanning speed of the laser beams. The overlarge melt pool generated in operation 204A corresponds to a long molten state duration because material at a given location experiences elevated temperatures above the melting point for the time required for the large melt pool to pass that location. The molten state duration for a given point can be estimated as the melt pool length in the scanning direction (along the line passing the point) divided by the scanning speed. The overlong molten state duration provides extended time for melt flow to occur before solidification, enabling more significant material redistribution than would occur with a shorter molten state duration. Operation 206A shows how the overlarge melt pool from operation 204A translates into a temporal problem that exacerbates melt flow issues.

At operation 208A, the process 200A involves enabling excessive melt flow driven by surface tension and/or other factors. The extended time that material remains molten in operation 206A provides opportunity for surface tension forces and/or other forces to drive flow of the molten ceramic. The excessive melt flow redistributes molten ceramic in the melt pool, potentially accumulating material in some regions while depleting material in other regions. The large volume of molten material created by the overlarge melt pool in operation 204A combined with the long duration from operation 206A enables the melt flow in operation 208A to potentially become severe enough to cause significant material irregularity. Operation 208A demonstrates the fluid dynamics problem that results from the combination of overlarge melt pool size and overlong molten state duration.

The process 200A concludes at operation 210A with the result of melt overflow, balling, irregularity, and/or material accumulation at boundaries. The excessive melt flow from operation 208A can cause molten ceramic to overflow beyond the intended track boundaries, creating regions where solidified material extends outside the desired part geometry. The melt flow due to surface tension can drive material into spherical or near-spherical shapes, creating the balling phenomenon where discrete balls of solidified ceramic form rather than continuous track material. The redistribution of molten material can create irregular track morphology with variations in track width, thickness, and/or continuity along the scan path. Material can accumulate at track boundaries where melt flow has transported some molten ceramic away from the track center, forming raised edges or ridges of solidified material. Operation 210A demonstrates the material quality defects that can often prevent dual continuous wave laser systems from producing high-quality ceramic parts despite the potential benefits of dual-beam processing.

The process 200A illustrates why conventional dual-beam approaches using two continuous wave laser beams may fail to achieve the material quality needed for ceramic additive manufacturing. The continuous operation of both beams creates a thermal situation that combines overlarge melt pool formation, extended molten state duration, and excessive undesirable melt flow problems. These issues may prevent formation of continuous, densified, uniform ceramic tracks necessary for building high-quality ceramic parts through layer-by-layer additive manufacturing. The quality problem-generation mechanisms shown in process 200A establish the technical problem that the PC-DB-SLM system 100 of FIG. 1A addresses.

In some embodiments, operation 202A involves applying two continuous wave laser beams with average powers between 20 watts and 1000 watts each. In some embodiments, both continuous wave laser beams have spot sizes between 100 micrometers and 30 millimeter on the powder layer surface. In some embodiments, the molten state duration is calculated as the melt pool length divided by the scanning speed. In some embodiments, the balling in operation 210A produces spherical particles with diameters larger than the original powder particle size. In some embodiments, the process 200A applies to carbide or oxide ceramic material. In some embodiments, the scanning speed during process 200A ranges from 20 millimeters per second to 300 millimeters per second.

FIG. 2B illustrates a flowchart showing the expected quality-problem generation mechanisms of single-beam laser powder bed fusion according to some embodiments. The flowchart 200B demonstrates the material quality challenges often encountered when only a single laser beam is used for ceramic powder processing rather than the dual-beam combination disclosed in FIGS. 1A through 1D. The process 200B represents single-beam selective laser melting (SLM) wherein a melting laser beam operates without an accompanying heating laser beam. The flowchart 200B provides context for understanding how the addition of the heating laser beam 114 in the PC-DB-SLM system 100 of FIG. 1A can potentially address temperature gradient challenges that single-beam approaches are difficult to resolve.

The process 200B begins at operation 202B, which involves applying a single laser beam to ceramic powder. During operation 202B, a laser beam directs onto a powder layer surface to melt ceramic powder. The single laser beam may operate in pulsed mode similar to the first laser beam 112 of FIG. 1A or in continuous wave mode. The single laser beam functions as a melting beam to create a melt pool in the ceramic powder. No second laser beam is present to heat the surrounding region and reduce temperature gradients as the second laser beam 114 can potentially do in the PC-DB-SLM system 100 of FIG. 1A. The single laser beam scans on the powder layer to process ceramic powder through melting and resolidification. Operation 202B establishes the single-beam configuration that may lead to the temperature gradient problems shown in the following operations.

At operation 204B, the process 200B involves generating a large temperature gradient in the melt pool and/or the solid region. The absence of a heating laser beam means that the temperature gradient can remain large. Operation 204B demonstrates the thermal problem that results from lacking a heating beam to reduce temperature gradients.

Operation 206B involves creating a large surface tension gradient and/or thermal stresses in the solid. The surface tension of molten ceramic material varies with temperature. The large temperature gradient in the melt pool generated in operation 204B creates a correspondingly large gradient in surface tension in the melt pool. The surface tension gradient creates a driving force for fluid flow in the molten ceramic. Operation 206B shows how the temperature gradient problem from operation 204B translates into a surface tension gradient that drives melt flow and/or thermal stresses in the solid region.

At operation 208B, the process 200B involves driving melt flow driven by surface tension gradients and/or generating cracks in the solid due to thermal stresses. The surface tension gradient created in operation 206B can generate flow of molten ceramic. This melt flow phenomenon can redistribute molten material within the melt pool, transporting material away from certain portion(s) of the melt pool to other portion(s). The melt flow can potentially fragment the melt pool into separate regions of molten material or create irregular shapes as material accumulates in certain areas while depleting from others. The melt flow may continue when the material remains molten and surface tension gradients exist. Operation 208B demonstrates how the surface tension gradient from operation 206B causes problematic material redistribution during processing and/or the thermal stresses from operation 206B causes cracks in the solid region.

The process 200B concludes at operation 210B with the result of material fragmentation, irregularity and/or cracks. The melt flow driven by surface tension gradients in operation 208B changes the melt pool into irregular and/or fragmented shapes rather than maintaining a continuous pool. When melt pool solidifies, the resulting ceramic track can exhibit irregularity with gaps, discontinuities, variations in width and thickness, and/or non-uniform material distribution. The material irregularity can prevent formation of high-quality ceramic parts with consistent properties and geometries. Operation 210B demonstrates the material quality defects that often prevent single-beam laser systems from producing desirable quality for additive manufacturing applications.

The process 200B illustrates why single-beam approaches can potentially fail to achieve the material quality needed for ceramic additive manufacturing. The absence of a heating beam to reduce temperature gradients can create a situation where large temperature gradients drive severe surface tension gradients (and resulting melt flow) in the melt pool and/or generate thermal stresses (and resulting cracks) in the solid region. These issues can cause melt pool fragmentation, material irregularity and/or cracks that compromise track quality. The expected failure mechanisms shown in process 200B establish the technical problem that the heating laser beam 114 in the PC-DB-SLM system 100 of FIG. 1A can potentially address through temperature gradient reduction.

In some embodiments, operation 202B involves applying a laser beam with an average power between 10 watts and 1000 watts. In some embodiments, the single laser beam operates in pulsed mode with pulse durations between 1 microsecond and 10 microseconds and pulse repetition rates between 10 kilohertz and 50 kilohertz. In some embodiments, the single laser beam operates in continuous wave mode. In some embodiments, the laser beam has a spot size between 50 micrometers and 1 millimeter on the powder layer surface. In some embodiments, the temperature gradient in operation 204B can exceed 1000 Kelvin per millimeter in the melt pool. In some embodiments, the process 200B applies to carbide ceramic material. In some embodiments, the scanning speed during process 200B ranges from 20 millimeters per second to 300 millimeters per second.

FIG. 2C illustrates a flowchart showing the process sequence and successful operation of pulsed-continuous dual-beam selective laser melting (PC-DB-SLM) according to some embodiments. The flowchart 200C demonstrates the operational progression of the PC-DB-SLM system 100 disclosed in FIG. 1A and how the coordinated functions of the pulsed melting beam and continuous wave heating beam can potentially address the challenges shown in FIGS. 2A and 2B. The process 200C represents the pulsed-continuous dual-beam selective laser melting (PC-DB-SLM) method wherein a pulsed melting laser beam and a continuous wave heating laser beam operate together to potentially achieve high-quality ceramic part fabrication. The flowchart 200C illustrates how the disclosed approach can potentially overcome the overlarge melt pool problems of dual continuous wave systems shown in FIG. 2A and the temperature gradient problems of single-beam systems shown in FIG. 2B.

The process 200C begins at operation 202C, which involves applying a pulsed melting beam to ceramic powder. During operation 202C, the first laser beam 112 of FIG. 1A directs onto a powder layer surface in pulsed mode to melt ceramic powder. The pulsed melting beam delivers discrete bursts of laser energy to the powder layer rather than continuous energy delivery. The pulsed melting beam irradiates a first region of the powder layer to create a melt pool where ceramic particles undergo melting and coalescence. The pulsed operation provides high intensity during each pulse while limiting the total energy delivered over time and/or the size of the energy-affected region in the powder layer. Operation 202C establishes the pulsed melting function that can potentially address both the insufficient melting and overlarge melt pool challenges.

At operation 204C, the process 200C involves generating high transient intensity to melt powder while limiting the energy-affected zone. The pulsed melting beam from operation 202C creates a transient peak power density during each pulse that is large enough to fully melt at least some ceramic particles in the irradiated region. The high transient intensity ensures complete particle melting rather than partial melting. The pulsed operation simultaneously limits the energy-affected zone because laser energy is delivered only during the pulse duration rather than continuously. The limited energy-affected zone can potentially prevent formation of an overlarge melt pool that could lead to excessive melt flow and balling as shown in FIG. 2A. The energy density absorbed by the powder and energy-affected region size remain controlled through adjustment of pulse duration, pulse repetition rate, and duty cycle. Operation 204C demonstrates how the pulsed melting beam can potentially achieve both adequate extent of melting and melt pool size control, objectives that are difficult to achieve simultaneously with continuous wave beams.

Operation 206C involves applying a continuous wave heating beam with a larger spot size. During operation 206C, the second laser beam 114 of FIG. 1A directs onto the powder layer surface in continuous wave mode to heat ceramic powder in a second region that overlaps, partially overlaps, or is adjacent to the first region where the pulsed melting beam creates the melt pool. The continuous wave heating beam delivers laser power continuously when it is not turned off. The heating beam with a suitable intensity, size and location can modify the temperature field created by the melting beam and potentially decrease the temperature gradients created by the melting beam in and/or around the melt pool. Typically, the heating beam moves together with the pulsed melting beam relative to the powder layer surface, maintaining suitable relative beam locations. Operation 206C establishes the continuous wave heating function that can potentially address the temperature gradient challenges shown in FIG. 2B.

At operation 208C, the process 200C involves reducing temperature gradient and surface tension gradient in the melt pool, and/or reducing temperature gradient and thermal stresses in the solid region. The continuous wave heating beam from operation 206C can potentially decrease the temperature gradients in and/or near the melt pool. The reduced temperature gradient in the melt pool decreases the corresponding surface tension gradient because surface tension varies with temperature. The decreased surface tension gradient reduces the driving force for melt flow driven by surface tension gradients. The heating beam can also potentially reduce temperature gradients in the solid region formed by re-solidification of melted powder, decreasing thermal stresses that could cause cracking. Operation 208C demonstrates how the heating beam can potentially address the temperature gradient problems in single-beam systems as shown in FIG. 2B.

Operation 210C involves limiting melt flow space and time. The pulsed operation of the melting beam limits the size of the melt pool compared to a continuous wave melting beam, providing less space for melt flow to redistribute material. The limited energy-affected zone from operation 204C corresponds to a smaller melt pool that reduces the distance over which melt flow can transport material. The pulsed operation also limits the duration that material remains in the molten state because the melt pool forms or expands during laser pulses and begins cooling between pulses. The limited molten state duration provides less time for melt flow to occur before solidification. The reduced temperature and surface tension gradients from operation 208C further limit melt flow by decreasing the driving force for fluid motion in the molten ceramic. The combination of smaller melt pool size, shorter molten state duration, and reduced flow driving force enables the material to potentially solidify before excessive redistribution occurs. Operation 210C shows how the coordinated functions of the pulsed melting beam and CW heating beam work together to control melt flow.

The process 200C concludes at operation 212C with the potential result of continuous, densified, uniform material with no or few cracks. The limited melt flow from operation 210C can potentially enable the molten ceramic to fill voids between powder particles and create a continuous solidified track without the excessive flow that would cause balling, material overflow, irregularity and/or fragmentation. The resulting ceramic track can exhibit continuity along its length without obvious gaps or discontinuities. The track demonstrates densification with reduced porosity compared to the original powder layer as melted particles coalesce and fill interparticle spaces. The track can show good uniformity in width, thickness, and material distribution without the irregularity often produced by dual continuous wave systems as shown in FIG. 2A or single-beam systems as shown in FIG. 2B. The good track quality indicates that the melt pool size and flow characteristics remained desirably controlled throughout processing. Operation 212C demonstrates the high-quality material outcomes potentially achievable through the PC-DB-SLM process 200C.

The process 200C illustrates how the pulsed-continuous dual-beam approach can potentially achieve much better ceramic part quality than conventional single-beam and dual continuous wave approaches. The pulsed melting beam can potentially address both insufficient melting and overlarge melt pool challenges through high transient intensity and limited energy density and/or size of energy-affected zone. The continuous wave heating beam can potentially address temperature gradient challenges by modifying the temperature field created by the melting beam. The coordinated operation of both beams enables production of potentially continuous, densified, uniform ceramic tracks with no or few cracks suitable for layer-by-layer additive manufacturing of high-quality ceramic parts.

In some embodiments, operation 202C involves applying a pulsed melting beam with an average power between 10 watts and 300 watts. In some embodiments, the pulsed melting beam has a pulse duration between 1 microsecond and 100 microseconds and a pulse repetition rate between 5 kilohertz and 100 kilohertz. In some embodiments, the pulsed melting beam creates a spot on the powder layer surface with a diameter between 50 micrometers and 900 micrometers. In some embodiments, the energy-affected zone (wherein the peak temperature reaches the melting point) in operation 204C has dimensions less than 1 millimeter. In some embodiments, operation 206C involves applying a continuous wave heating beam with an average power between 30 watts and 300 watts. In some embodiments, the heating beam creates a spot on the powder layer surface with dimensions between 2 millimeters and 10 millimeters. In some embodiments, the spot size of the heating beam is at least three times larger than the spot size of the melting beam. In some embodiments, the melt pool size in operation 210C remains below 1 millimeter in width. In some embodiments, the densified material in operation 212C achieves porosity below 15 percent. In some embodiments, the process 200C applies to chromium carbide ceramic material. In some embodiments, the scanning speed during process 200C ranges from 10 millimeters per second to 300 millimeters per second.

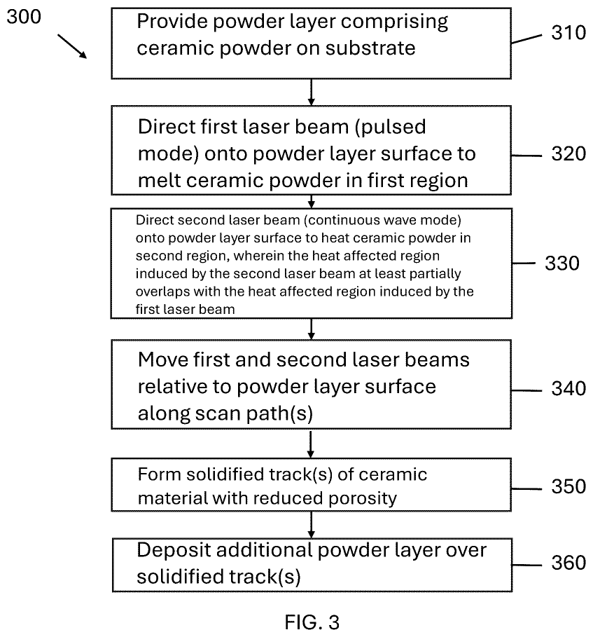

FIG. 3 illustrates a flowchart showing the method of additive manufacturing using the pulsed-continuous dual-beam selective laser melting (PC-DB-SLM) process according to some embodiments. The flowchart 300 demonstrates the operational sequence for manufacturing ceramic parts using the PC-DB-SLM system 100 described in FIG. 1A. The method 300 outlines the steps involved in processing ceramic powder layers to produce densified ceramic material through coordinated pulsed melting and continuous wave heating laser operations. The flowchart 300 provides a systematic approach to potentially achieving the high-quality ceramic part fabrication enabled by the disclosed dual-beam process.

The method 300 begins at operation 310, which involves providing a powder layer comprising ceramic powder on a substrate. During operation 310, ceramic powder is deposited onto the solid surface 104 of FIG. 1A to form the powder layer 102. The ceramic powder spreads on the substrate surface to create a layer with controlled thickness suitable for laser processing. The powder layer comprises particles of ceramic material with spaces between particles, creating a porous structure prior to laser irradiation. The substrate provides a stable base that supports the powder layer during processing and maintains positional accuracy throughout the additive manufacturing operation. The thickness of the powder layer determines the layer height increment for building three-dimensional parts through sequential layer processing. Operation 310 establishes the initial material configuration that will undergo laser-induced melting and resolidification in subsequent operations.

At operation 320, the method 300 involves directing a first laser beam in pulsed mode onto the powder layer surface to melt ceramic powder in a first region. The first laser beam 112 of FIG. 1A irradiates a selected region of the powder layer 102 surface. The first laser beam operates in pulsed mode to deliver discrete bursts of laser energy. The pulsed first laser beam creates high transient power density during each pulse sufficient to fully melt at least some ceramic particles in the first region. The melting of ceramic particles initiates coalescence as adjacent melted particles flow together. The first region where melting occurs defines the area that will become part of the solidified ceramic track after cooling. The pulsed operation limits the total energy delivered to the powder layer over time and the size of the energy-affected zone in the powder layer, controlling the size of the melt pool formed in the first region. Operation 320 establishes the melting function that creates the molten ceramic material necessary for densification.

Operation 330 involves directing a second laser beam in continuous wave mode onto the powder layer surface to heat ceramic powder in a second region, wherein the second laser beam spot size is typically (but not necessarily always) larger than the first laser beam spot size, and wherein the regions overlap, partially overlap, or are close to each other. The second laser beam 114 of FIG. 1A heats the powder layer 102 surface in a region that overlaps with, partially overlaps with, or is close to the first region where the first laser beam creates melting. The second laser beam operates in continuous wave mode, delivering laser power continuously with time when it is not turned off. The second laser beam with a suitable intensity, spot size and location can potentially modify the temperature field created by the first laser beam. The heating function of the second laser beam can potentially reduce temperature gradients of the material in the melt pool created by the first laser beam and/or the surrounding solid material. The close locations of the first and second regions enable the second laser beam to affect the thermal conditions in the area where the first laser beam creates temperature gradients. Operation 330 establishes the heating function that can potentially address temperature gradient challenges.

At operation 340, the method 300 involves moving the first and second laser beams (typically together) relative to the powder layer surface along a scan path or paths. The first laser beam 112 and second laser beam 114 of FIG. 1A move in a coordinated manner on the powder layer 102 surface. The scan path(s) defines the route that the laser beams follow across the powder layer, determining the geometry of the ceramic track(s) that will form. Typically, the first and second laser beams maintain their relative positioning as they move together, ensuring that the heating zone created by the second laser beam continues to encompass, or at least partially overlap with, the melting zone and/or heating zone created by the first laser beam throughout the scanning operation. Typically, the beams move at the same speed along the scan path(s) to maintain synchronized operation. The motion of the beams on the powder layer progressively processes ceramic powder along the scan path, potentially creating a continuous track or tracks of melted and resolidified material. The scan path(s) may follow straight lines, curved trajectories, or complex patterns depending on the part geometry being manufactured. Operation 340 demonstrates the dynamic scanning process that extends the localized laser processing on the powder layer to create track(s) with desired lengths, widths and shapes.

Operation 350 involves forming a solidified track or multiple solidified tracks of ceramic material with reduced porosity. As the first and second laser beams move along the scan path(s) in operation 340, ceramic particles in the irradiated regions undergo melting, coalescence, and re-solidification. The melted ceramic particles flow together to fill interparticle spaces, reducing the porosity present in the original powder layer. After the laser beams pass a given location, the molten ceramic cools and solidifies, forming densified ceramic material. The solidified track(s) has reduced porosity compared to the powder layer because the melting and coalescence process removes or reduces many of the gaps that existed between particles. Each track can exhibit continuity along its length without significant gaps or fragmentation. The material in the track(s) can potentially achieve densification that provides mechanical properties suitable for structural applications. The track(s) forms part of the ceramic part being manufactured and may bond to the substrate or previously processed layer(s) beneath it. The moving of the laser beams on each powder layer can form one or multiple tracks, thereby generating the desired geometry of the bonded material region for the layer. Operation 350 demonstrates the material transformation that can potentially produce high-quality, densified ceramic material from powder feedstock.

At operation 360, the method 300 optionally involves depositing an additional powder layer over the solidified track(s). After operation 350 produces one or multiple solidified tracks on the current powder layer, a fresh layer of ceramic powder is spread over the solidified material to prepare for processing of the next layer. The additional powder layer covers the previously formed track(s) and fills the regions around the track or tracks to create a new powder bed surface at an elevated height. The thickness of the additional powder layer is consistent with the layer height increment used for building the three-dimensional part. The deposition of the additional powder layer enables continuation of the additive manufacturing process through sequential layer processing. Operation 360 represents the recoating step that transitions between processing of successive layers in a multi-layer build.

The method 300 optionally involves repeating the directing and moving steps on the additional layer of ceramic powder to form an additional solidified track or multiple additional solidified tracks, thereby building the ceramic part in a layer-by-layer manner. Following deposition of the additional powder layer in operation 360, operations 320, 330, and 340 repeat on the new powder layer surface. The first laser beam directs onto the additional powder layer in pulsed mode to melt ceramic powder. The second laser beam directs onto the additional powder layer in continuous wave mode to heat ceramic powder. Typically, the laser beams move together on the additional powder layer along a scan path(s) determined by the part geometry for that layer. The process forms an additional solidified track or multiple additional solidified tracks on the new layer that bond to the track(s) formed in the previous layer. The repetition of operations continues for each successive layer until the complete three-dimensional ceramic part is manufactured. The layer-by-layer approach enables fabrication of complex geometries that would be difficult or impossible to produce using traditional ceramic manufacturing methods.

The method 300 provides a systematic operational sequence for implementing the PC-DB-SLM process to manufacture ceramic parts with potentially improved quality compared to conventional laser powder bed fusion approaches. The combination of pulsed melting and continuous wave heating operations can potentially address the challenges of insufficient melting, overlarge melt pools, and high temperature gradients that often limit ceramic part quality in other SLM processes. The coordinated dual-beam approach can potentially enable production of ceramic parts with a high relative density, low surface roughness, and no or few cracks through additive manufacturing.

In some embodiments, operation 310 involves providing a powder layer with a thickness between 20 micrometers and 500 micrometers. In some embodiments, the ceramic powder in operation 310 comprises particles with sizes less than 100 micrometers. In some embodiments, the powder layer in operation 310 has an initial porosity between 40 percent and 70 percent. In some embodiments, operation 320 involves directing a first laser beam with a pulse duration between 1 microsecond and 100 microseconds. In some embodiments, operation 320 involves a pulse repetition rate between 5 kilohertz and 100 kilohertz. In some embodiments, the first laser beam in operation 320 has an average power between 10 watts and 300 watts. In some embodiments, the spot size of the first laser beam in operation 320 ranges from 50 micrometers to 900 micrometers. In some embodiments, operation 330 involves directing a second laser beam with an average power between 30 watts and 300 watts. In some embodiments, the spot size of the second laser beam in operation 330 ranges from 2 millimeters to 10 millimeters. In some embodiments, the spot size of the second laser beam is at least three times larger than the spot size of the first laser beam. In some embodiments, operation 340 involves moving the laser beams at speeds between 10 millimeters per second and 300 millimeters per second. In some embodiments, the solidified track in operation 350 achieves porosity below 15 percent. In some embodiments, the solidified track in operation 350 exhibits hardness values comparable to bulk ceramic material. In some embodiments, operation 360 involves depositing additional powder layers with thicknesses matching the initial layer thickness. In some embodiments, the layer-by-layer process repeats for 10 to 1000 layers to build ceramic parts with heights ranging from 1 millimeter to 100 millimeters. In some embodiments, the method 300 operates in an argon environment to prevent oxidation. In some embodiments, the ceramic powder comprises chromium carbide, aluminum oxide, zirconium oxide, or silicon carbide.

It is worth noting that additional operations or variations may be included in the method 300, depending on the specific requirements of the ceramic additive manufacturing application or the design of the PC-DB-SLM system 100. For example, the method may include operations for adjusting laser parameters based on ceramic material characteristics or part geometry requirements. Additionally, the method may involve operations for processing multiple tracks within a single layer to build wider features, enabling complete cross-sectional coverage of the part being manufactured. The method may also include operations for varying scan patterns, adjusting inter-layer timing to control cooling rates, or incorporating support structure fabrication for overhanging features.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is in no way intended that any particular order be inferred.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

Reference systems that may be used herein can refer generally to various directions (for example, upper, lower, forward and rearward), which are merely offered to assist the reader in understanding the various embodiments of the disclosure and are not to be interpreted as limiting. Other reference systems may be used to describe various embodiments, such as those where directions are referenced to the portions of the device, for example, toward or away from a particular element, or in relations to the structure generally (for example, inwardly or outwardly).

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

I/We claim:

1. A method for additive manufacturing of a ceramic part, structure or component, the method comprising:
providing a powder layer comprising ceramic powder disposed on a substrate, wherein the ceramic powder comprises particles having a porosity;
directing a first laser beam onto a surface of the powder layer to irradiate a first region of the powder layer, wherein the first laser beam is configured to melt at least some of the ceramic powder in the first region and induce a heat-affected region in the powder layer, wherein the first laser beam operates in a pulsed mode having a pulse duration and a pulse repetition rate;
directing a second laser beam onto the surface of the powder layer to irradiate a second region of the powder layer, wherein the second laser beam is configured to heat the ceramic powder in the second region, wherein the second laser beam operates in a continuous wave mode such that the second laser beam delivers laser power continuously for a predetermined time when it is turned on, wherein the heat-affected region induced by the second laser beam at least partially overlaps with the heat-affected region induced by the first laser beam; and
moving the first laser beam and the second laser beam relative to the surface of the powder layer along a same scan path or different scan paths, wherein the scan path or paths define a route or plurality of routes on the surface of the powder layer, to form at least one solidified track containing ceramic material, wherein the solidified track has a reduced porosity relative to the porosity of the original ceramic powder.

2. The method of claim 1, wherein the pulse duration and/or the pulse repetition rate of the first laser beam are adjustable, wherein the adjustment of the pulse duration and/or repetition rate can improve the quality of the ceramic part.

3. The method of claim 1, wherein a spot size of the second laser beam on the surface of the powder layer is larger than a spot size of the first laser beam on the surface of the powder layer.

4. The method of claim 1, wherein the spot of the first laser beam is fully contained within the spot of the second laser beam on the surface of the powder layer.

5. The method of claim 1, wherein the first laser beam and the second laser beam are moved together at a same velocity.

6. The method of claim 1, wherein the pulse duration of the first laser beam is between 1 microsecond and 500 microseconds.

7. The method of claim 1, wherein the pulse repetition rate of the first laser beam is between 1 kHz and 500 kHz.

8. The method of claim 1, wherein the first laser beam has an average power per second between 10 W and 1000 W.

9. The method of claim 1, wherein the second laser beam has an average power between 10 W and 1000 W.

10. The method of claim 1, wherein the ceramic powder comprises at least one of chromium carbide, aluminum oxide, or zirconium oxide.

11. The method of claim 1, wherein the second laser beam reduces a temperature gradient in the heat-affected region induced by the first laser beam.

12. The method of claim 1, further comprising:
depositing at least an additional layer of ceramic powder over the solidified one or multiple tracks; and
repeating the directing and moving steps on the additional layer of ceramic powder to form at least an additional solidified track, thereby building the ceramic part, structure or component in a layer-by-layer manner.

13. A system for additive manufacturing of a ceramic part, structure or component, the system comprising:
a substrate configured to support a powder layer comprising ceramic powder, wherein the powder layer has a porosity, wherein the porosity is defined by void spaces between particles of the ceramic powder;
a first laser source configured to generate a first laser beam and direct the first laser beam onto a surface of the powder layer to irradiate a first region of the powder layer, wherein the first laser beam is configured to melt at least some of the ceramic powder in the first region and induce a heat-affected region in the powder layer, wherein the first laser source operates in a pulsed mode having a pulse duration and a pulse repetition rate;
a second laser source configured to generate a second laser beam and direct the second laser beam onto the surface of the powder layer to irradiate a second region of the powder layer, wherein the second laser beam is configured to heat the ceramic powder in the second region, wherein the second laser source operates in a continuous wave mode such that the second laser beam delivers laser power continuously for a predetermined time when the second laser beam is turned on, wherein the heat affected region induced by the second laser beam at least partially overlaps with the heat affected region induced by the first laser beam; and
a motion mechanism configured to move the first laser beam and the second laser beam relative to the surface of the powder layer along a same scan path or different scan paths, wherein the scan path or paths defines a route or routes on the surface of the powder layer, to form at least one solidified track containing ceramic material, wherein the solidified track has a reduced porosity relative to the porosity of the original powder layer.

14. The system of claim 13, wherein the pulse duration and/or the pulse repetition rate of the first laser beam are adjustable, wherein the adjustment of the pulse duration and/or repetition rate can improve the quality of the ceramic part.

15. The system of claim 13, wherein the spot size of the second laser beam is larger than the spot size of the first laser beam on the surface of the powder layer.

16. The system of claim 13, wherein the spot of the first laser beam is fully contained within the spot of the second laser beam on the surface of the powder layer.

17. The system of claim 13, wherein the pulse duration of the first laser source is between 1 microsecond and 1000 microseconds, and wherein the pulse repetition rate of the first laser source is between 1 kHz and 500 kHz.

18. The system of claim 13, wherein the ceramic powder comprises at least one of chromium carbide, aluminum oxide, or zirconium oxide.

19. The system of claim 13, wherein the second laser beam reduces a temperature gradient in the heat-affected region induced by the first laser beam.

20. The system of claim 13, further comprising:
a powder dispenser configured to deposit at least an additional layer of ceramic powder over the solidified track or tracks,
wherein the motion mechanism is further configured to move the first laser beam and the second laser beam relative to the additional layer of ceramic powder to form at least an additional solidified track, thereby building the ceramic part, structure of component in a layer-by-layer manner.
